(19) United States
(12) Patent Application Publication
(10) Pub. No.: US 2005/0067952 A1
(43) Pub. Date: Mar. 31, 2005

(54) Flexible, molded EL lamp

(75) Inventors: Ramona Rae Fechter, Chandler, AZ (US); Mark Rogers, Mesa, AZ (US)

Correspondence Address: Paul F. Wille, 2225 West Chandler Boulevard, Chandler, AZ, 85224, US

(73) Assignees: Durel Corporation, Chandler, AZ (US); World Properties, Inc.

(21) Appl. No.: 10/674,275

(22) Filed: Sep. 29, 2003

(51) Int. Cl. H01J 1/62; H01J 63/04

(52) U.S. Cl. 313/506

(57) ABSTRACT

A flexible EL lamp is made by depositing successive layers onto a release layer. The lamp is molded into a substantially stiffer article, leaving the lamp as a portion of a surface of the article. In one embodiment of the invention, the lamp emits light through the article. In another embodiment, the lamp emits light from the exposed portion of the surface. The EL lamp, as molded, can be substantially flat or have a three dimensional shape. The lamp is molded with or without the release layer.

### BACKGROUND OF THE INVENTION

This invention relates to the combination of a thick film, inorganic, electroluminescent (EL) panel and, in particular, to the construction of an EL panel having relatively thin luminous areas.

As used herein, an EL “panel” is a single sheet including one or more luminous areas, wherein each luminous area is an EL “lamp.” An EL lamp is essentially a capacitor having a dielectric layer between two conductive electrodes, at least one of which is transparent. The dielectric layer can include a phosphor powder or there can be a separate layer of phosphor powder adjacent the dielectric layer. The phosphor powder radiates light in the presence of a strong electric field, using relatively little current.

A modern (post-1990) EL lamp typically includes transparent substrate of polyester or polycarbonate material having a thickness of about 7.0 mils (0.178 mm.). A transparent, front electrode of indium tin oxide or indium oxide is vacuum deposited onto the substrate to a thickness of 1000 Å or so. A phosphor layer is screen printed over the front electrode and a dielectric layer is screen printed over phosphor layer. A rear electrode is screen printed over the dielectric layer. It is also known in the art to deposit the layers by roll coating.

The inks used for screen printing or roll coating include a binder, a solvent, and a filler, wherein the filler determines the nature of the printed layer. A typical solvent is dimethylacetamide (DMAC). The binder is typically a fluoropolymer such as polyvinylidene fluoride/hexafluoropropylene (PVDF/HFP), polyester, vinyl, epoxy or Kynar 9301, a proprietary terpolymer sold by Atofina. A phosphor layer is typically screen printed from a slurry containing a solvent, a binder, and zinc sulphide particles. A dielectric layer is typically screen printed from a slurry containing a solvent, a binder, and particles of titania (TiO₂) or barium titanate (BaTiO₃). A rear electrode is typically screen printed from a slurry containing a solvent, a binder, and conductive particles such as silver or carbon. Because the solvent and binder for each layer are chemically the same or similar, there is chemical compatibility and good adhesion between adjoining layers.

A panel constructed in accordance with the prior art is relatively stiff, even though it is typically only seven mils thick, making it difficult to mold into a three dimensional surface, for example. Layer thickness and stiffness are not directly related. The material from which the layer is made affects stiffness. Typically, EL lamps are made from the materials listed above, which produces an undesirable stiffness. Simply reducing thickness does not provide the desired flexibility.

EL lamps made with polyurethane layers are known; see U.S. Pat. No. 4,297,681 (Dircksen). An EL panel encapsulated in an envelope is known in the art; see U.S. Pat. No. 4,138,620 (Dickson) and U.S. Pat. No. 4,181,925 (Burrows). U.S. Pat. No. 5,856,030 (Burrows) discloses an EL panel having a urethane layer on release paper as a substrate. The release paper provides structural support while other lamp layers are applied. A second layer of urethane is deposited and is attached to the first layer of urethane around the periphery of the panel to enclose the lamp layers in a urethane envelope.

Relatively flexible EL panels are known in the art. Unlike panels made on substrates that are seven mils thick, or so, EL panels made on thin substrates from flexible materials, e.g. urethane one to five mils thick, do not keep their shape but bend or curl. This makes it difficult to automate the assembly of panels into end products, e.g. a front cover for a cellular telephone.

It is known to mold EL lamps into translucent or transparent articles; e.g. see U.S. Pat. No. 4,619,624 (Kerr III et al.), U.S. Pat. No. 5,565,733 (Krafcik et al.), U.S. Pat. No. 5,780,965 (Cass et al.), PCT published application WO 03/025890 (Nissha Printing Co.), and Japanese patent abstract 11-162633 (Nissha Printing Co.), In general, the molded lamp becomes an internal member of the molded part, restricting needed access to electrical terminals. In addition, it is difficult to predict or control the final shape of the EL lamp, unless the lamp is preformed and includes a relatively stiff (self-supporting) substrate such as the of polyester or polycarbonate substrates described above. Finally, an internal EL lamp may limit the type or extent of graphics applied to a major surface of an article or to the lamp itself.

In view of the foregoing, it is therefore an object of the invention to provide a flexible, moldable EL lamp.

Another object of the invention is to provide a molded article wherein an EL lamp is molded into the article but forms a portion of the outer surface of the article.

A further object of the invention is to provide an EL lamp that simplifies molding the lamp into an article.

Another object of the invention is to eliminate the envelope around a flexible EL panel.

A further object of the invention is to provide an EL lamp that is compatible with a wide range of graphics and textures on the EL lamp.

Another object of the invention is to provide an EL lamp that is compatible with a wide range of graphics and textures in an article containing the EL lamp.

### SUMMARY OF THE INVENTION

The foregoing objects are achieved in this invention in which a flexible EL lamp is made by depositing successive layers onto a release layer. The lamp is molded into a substantially stiffer article, leaving the lamp as a portion of a surface of the article. In one embodiment of the invention, the lamp emits light through the article. In another embodiment, the lamp emits light from the exposed portion of the surface. The EL lamp, as molded, can be substantially flat or have a three dimensional shape. The lamp is molded with or without the release layer.

### BRIEF DESCRIPTION OF THE DRAWINGS

A more complete understanding of the invention can be obtained by considering the following detailed description in conjunction with the accompanying drawings, in which:

FIG. 1 is a cross-section of an EL lamp constructed in accordance with the prior art;

FIG. 2 is a cross-section of an EL lamp constructed in accordance with a preferred embodiment of the invention;

FIG. 3 is a cross-section of an EL lamp constructed in accordance with an alternative embodiment of the invention;

FIG. 4 is a schematic illustration of a mold for molding an EL lamp in accordance with a preferred embodiment of the invention;

FIG. 5 is a cross-section of an article molded in accordance with the invention;

FIG. 6 is a schematic illustration of a mold for molding an EL lamp in accordance with an alternative embodiment of the invention;

FIG. 7 is a cross-section of an article molded in accordance with the invention;

FIG. 8 is a cross-section of an EL lamp constructed in accordance with the invention;

FIG. 9 is a cross-section of an EL lamp constructed in accordance with the invention located in a mold for a three dimensional article;

FIG. 10 is a cross-section of a three dimensional article including an EL lamp embedded in the article according to the invention;

FIG. 11 is a cross-section of a three dimensional article made according to an alternative embodiment of the invention;

FIG. 12 is an instrument cluster molded in three dimensions and including EL backlighting in accordance with the invention; and

FIG. 13 is a cellular telephone having a molded cover containing an EL lamp constructed in accordance with the invention.

### DETAILED DESCRIPTION OF THE INVENTION

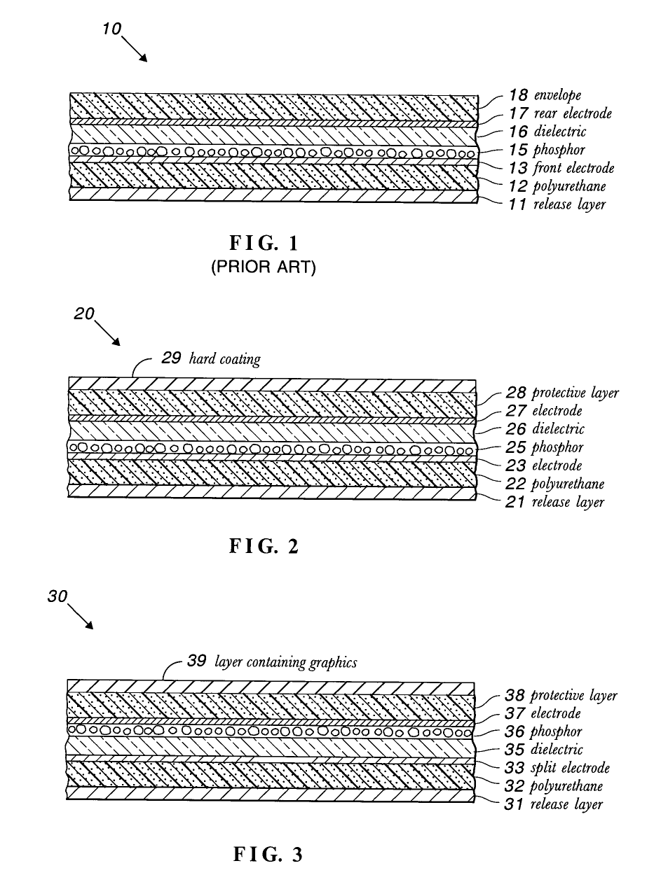

FIG. 1 is a cross-section of an EL lamp constructed in accordance with the prior art. The various layers are not shown in proportion. In lamp 10, release film 11 supports thin, transparent substrate 12, such as polyurethane. Transparent front electrode 13 overlies substrate 12 and is a thin, conductive layer of indium tin oxide or indium oxide. Phosphor layer 15 overlies the front electrode and dielectric layer 16 overlies the phosphor layer. Layers 15 and 16 are combined in some applications. Overlying dielectric layer 16 is opaque rear electrode 17. Polyurethane layer 18 seals lamp 10 about the periphery thereof (not shown). Coated phosphor particles can be used. None of the layers is drawn to scale. Layer 18, for example, is 1 mil. (0.025 mm) thick, as are the phosphor layer and the dielectric layer.

FIG. 2 is a cross-section of an EL lamp constructed in accordance with a preferred embodiment of the invention and including a hard coating on the resin side of the lamp. In accordance with the invention, either or both electrodes can be translucent. This enables lamp 20 to be used for lighting through a molded article or from a major surface of the article.

In FIG. 2, lamp 20 includes release layer 21 with polyurethane layer 22 deposited thereon, e.g. by screen printing or other technique known in the art. It is an advantage of the invention that known techniques can be used for making the EL lamp and for injection molding the lamp, although, as noted later, it is preferred to run the injection molding apparatus below approximately 270° F. (132° C.) to protect the ink layers. The release layer is a coated paper or a plastic sheet, such as PET, supplied in rolls, which facilitates handling the lamps and supplying the lamps to molding apparatus.

Electrode 23 overlies layer 22 and is a thin, conductive layer of indium tin oxide or indium oxide or a screen printed conductor. Phosphor layer 25 overlies electrode 23 and dielectric layer 26 overlies the phosphor layer. Electrode 27 overlies dielectric layer 26 and is made by screen printing a conductive ink. Polyurethane layer 28 overlies electrode 28 and provides a protective function. Layer 29 is a hard coating, e.g. a UV curable clear coating that provides some scratch resistance and insulates the ink layers (e.g. 25, 26, and 27) from the heat of the injected resin. Suitable materials are commercially available, such as Nazdar 641109PS SPL. In some applications, those not requiring extensive bending, protective layer 28 can be omitted in favor of hard coating 29.

FIG. 3 is a cross-section of an EL lamp constructed in accordance with a preferred embodiment of the invention and including a graphics layer. Lamp 30 includes release layer 31 with polyurethane layer 32 deposited thereon. Split electrode 33 overlies layer 32 and is a thin layer of indium tin oxide or indium oxide or a printed layer. Split electrode 33 can be used to simplify coupling power to the lamp or to provide a patterned electrode for displaying a graphic design or a legend. Alternatively, the split can be omitted. If electrode 33 is screen printed, the split is simply part of the pattern. If electrode 33 is formed by other means, laser ablation can be used to pattern the electrode.

Phosphor layer 35 overlies split electrode 33 and dielectric layer 36 overlies the phosphor layer. Electrode 37 overlies dielectric layer 36. Polyurethane layer 38 overlies electrode 38 and provides a protective function. Layer 39 is a graphics layer that also insulates the ink layers (e.g. 35, 36, and 37) from the heat of the injected resin. Preferably, layer 39 is a layer of polycarbonate, 5-10 mils (0.127-0.254 mm.) thick, having graphics printed thereon. In some applications, those not requiring extensive bending, Protective layer 38 can be omitted in favor of graphics layer 39.

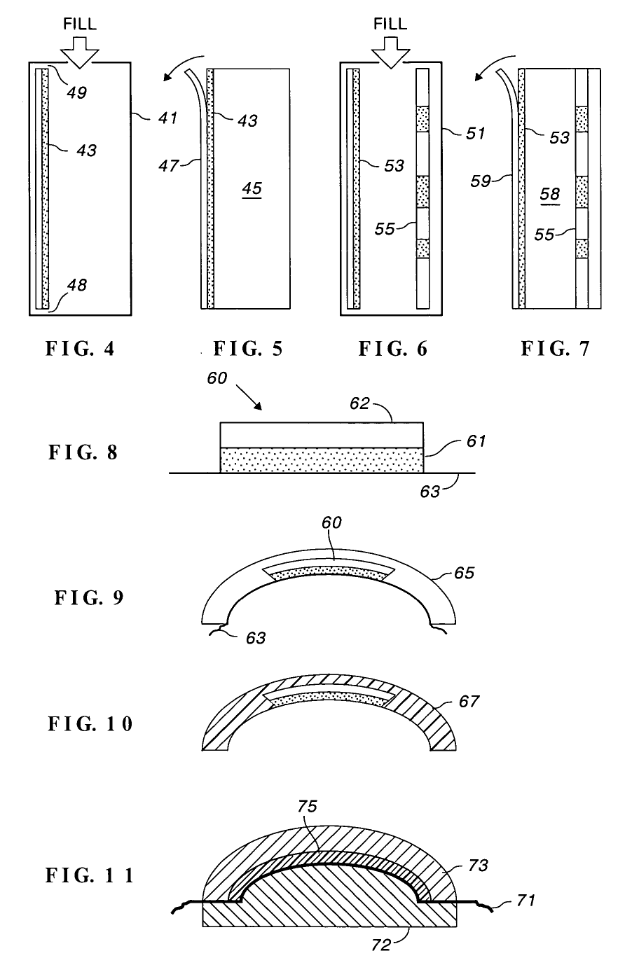

Lamp 20 and lamp 30 are suitable for use in injection molding processes known in the art. FIG. 4 is a schematic cross-section of injection mold 41 in which EL lamp 43 is located against one side of the mold. After resin is injected and cured, molded article 45, illustrated in FIG. 5, is removed from the mold and release layer 47 can be removed from the article. Lamp 43 is integral part of the article and yet the terminals of the lamp are readily accessible and can be located anywhere in the lamp area, although it is usually preferred to locate the terminals along one edge of the lamp. Optionally, a gap between EL lamp 43 and mold 41, such as gap 48 and gap 49, can be used to permit a small amount of resin to cover the edges of lamp 43. This can be done for appearance sake, to provide a frame for example, or to enclose the edges of lamp 43. Release layer is removed to expose substantially the entire area of lamp 43.

FIGS. 6 and 7 illustrate an alternative embodiment of the invention in which a graphic layer is included in the mold adjacent a second major surface of the mold. While illustrated as located opposite EL lamp 53, graphics layer 55 could be located at the bottom of mold 51 or at the sides parallel to the plane of the drawing. The locations of the graphic layer and the EL lamp are determined by the particular application. As illustrated in FIG. 7, after the resin has cured, article 58 is removed from the mold and release layer 59 is removed.

Because the invention is compatible with known lamp manufacturing processes and materials and with known injection molding apparatus and materials, virtually any injection molded product that one wanted to illuminate can benefit from the invention, particularly those with three dimensional luminous surfaces. FIGS. 8, 9, and 10 illustrate the manufacture of an article having a three dimensional luminous surface and constructed in accordance with the invention.

FIG. 8 is a cross-section of EL lamp 60 constructed in accordance with the invention and including hard coating 62 and release layer 63. In FIG. 9, lamp 60 has been placed in a curved injection mold. In FIG. 10, curved article 67 has been removed from the mold and release layer 63 has been removed. Article 67 can be any desired component or part, such as a flip-up cover for a cellular telephone, a cover for a personal digital assistant (PDA), or, on a smaller scale, a luminous key in a switch in a vehicle.

FIG. 11 is a cross-section of a three dimensional article made according to an alternative embodiment of the invention. In this embodiment, the release liner is removed, leaving EL lamp 71. EL lamp 71, which now has about the same structural stability as thin, plastic wrap for storing foods, is held by the edges in a suitable frame (not shown) and laid over a mold including base 72 and upper shell 73. Lamp 71 is preferably vacuum formed to base 72 prior to molding, rather than formed and molded in a single step. Then the mold is closed and a suitable resin injected. Resin 75 adheres to lamp 71, which forms an outer surface of the article. The excess portions of lamp 71 are removed from the edges of the article. As illustrated in FIG. 11, EL lamp 71 is on the concave side of the article. EL lamp 71 could just as well be on the convex side of the article.

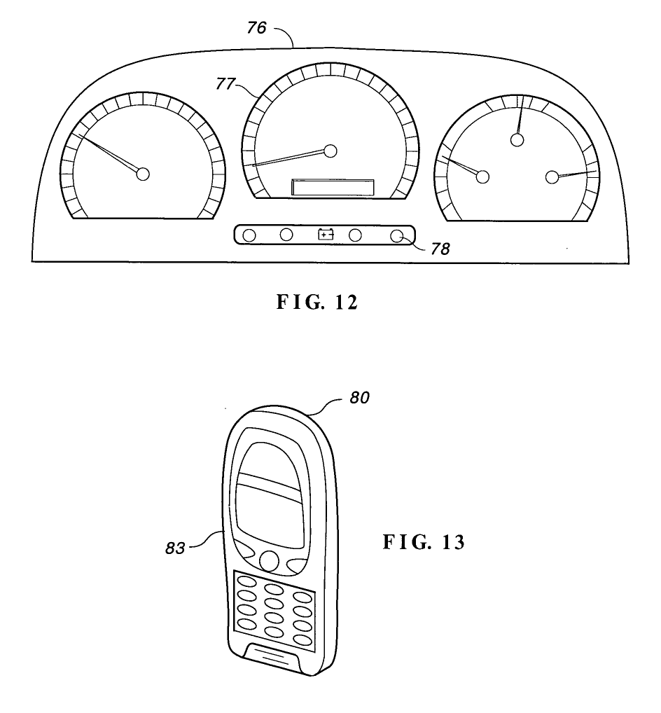

FIG. 12 is a plan view of instrument cluster 76 for a vehicle including a plurality of EL lamps. The entire graphics and lighting portion of cluster 76 can be made in a single piece in accordance with the invention. For some areas, such as speedometer 77, EL lamps emit through a graphic overlay, as illustrated in FIGS. 3, 6, and 7, whereas, in other areas such as warning lamp 78, an EL lamp emits outwardly from the molded article, such as illustrated in FIG. 2.

FIG. 13 is a perspective view of cellular telephone 80, which similarly can include a plurality of EL lamps emitting through or from cover 83.

The invention thus provides a flexible, moldable EL lamp that forms part of the outer surface of an injection molded article. The stability of the EL lamp on the release layer simplifies molding the lamp into an article, which can eliminate the envelope around a flexible EL panel. An EL lamp constructed in accordance with the invention is compatible with a wide range of graphics and textures on the EL lamp and in an article containing the EL lamp.

As used herein, a “surface” is meant to include substantially flat planes and three dimensional shapes not including sharp breaks or corners; that is, without what would be described mathematically as discontinuities; e.g. an abruptly changing radius of curvature. A mathematical definition of “surface” is not intended here, particularly with regard to thickness. The EL lamp is or intersects the outer surface of the article. As applied to surfaces that are continuous and enclose a volume, e.g. rings, ovoids, or spheroids, a “surface” is what generally faces in one direction or is what can be seen at a normal viewing distance without rotation of the article.

Having thus described the invention, it will be apparent to those of skill in the art that various modifications can be made within the scope of the invention. For example, the procedure described above uses a single “shot” or injection of resin. One can make an article in accordance with the invention in a two shot mold by shaping the mold to protect the electrical leads, to prevent resin from covering the leads during the second injection. The release layer is removed, partially removed, or left in place between injections, as desired. FIG. 2 and FIG. 3 illustrate several features in combination but are not exhaustive of the possible combinations. For example, the EL lamp illustrated in FIG. 2 can have the phosphor and dielectric layers reversed to facilitate emitting light through the hard coating.

1. An injection molded article having an electroluminescent panel as a first surface of the article, said panel comprising:
a transparent first layer;
a first conductive layer overlying said first layer;
a second conductive layer,
a dielectric layer and a phosphor layer between said first conductive layer and said second conductive layer;
a protective layer overlying the second conductive layer; and
a removable release layer overlying the protective layer to support the other layers during injection molding.

2. The article as set forth in claim 1 wherein said panel emits light outwardly from the surface.

3. The article as set forth in claim 1 wherein said panel emits light into said article.

4. The article as set forth in claim 1 wherein said outer surface is three dimensional.

5. The article as set forth in claim 1 wherein said transparent first layer and said protective layer are polyurethane.

6. The article as set forth in claim 1 and further including a hard coating layer underlying said transparent first layer.

7. The article as set forth in claim 1 and further including a UV curable resin underlying said transparent first layer.

8. The article as set forth in claim 1 and further including a graphics layer underlying said first transparent layer.

9. The article as set forth in claim 1 and further including a graphics layer adjacent a second surface of said article.

10. A method for making an article having a luminous surface, said method comprising the steps of:
depositing a first translucent layer on a release layer;
depositing a first electrode on the first translucent layer;
depositing a phosphor layer or a dielectric layer on the first electrode;
depositing a dielectric layer or a phosphor layer on the preceding layer;
depositing a second electrode on the preceding layer;
depositing a protective layer on the second electrode;
curing the deposited layers;
placing the release layer and cured layers in a mold with the release layer facing outwardly;
injecting resin into the mold behind the protective layer;
curing the resin;
removing the article from the mold; and
removing the release layer.

11. The method as set forth in claim 10 wherein at least one of the depositing steps is the step of screen printing.

12. The method as set forth in claim 10 wherein at least one of the depositing steps is roll coating.

13. The method as set forth in claim 10 wherein the protective layer is UV curable resin and the curing step includes the step of irradiating the protective layer with UV radiation.

14. The method as set forth in claim 10 wherein the curing step is performed after each depositing step.

15. The method as set forth in claim 10 and further including the step of:
placing a graphics layer in said mold, separated from said release layer.

16. The method as set forth in claim 15 wherein said injecting step includes the step of injecting resin at least between said protective layer and said graphics layer.

17. An instrument cluster having at least one electroluminescent lamp as a first surface in a molded portion of the cluster, said lamp comprising:
a transparent first layer;
a first conductive layer overlying said first layer;
a second conductive layer,
a dielectric layer and a phosphor layer between said first conductive layer and said second conductive layer;
a protective layer overlying the second conductive layer; and
a removable release layer overlying the protective layer to support the other layers during molding.

18. The instrument cluster as set forth in claim 17 and further including a plurality of electroluminescent lamps, wherein at least some of the lamps include a graphics layer.

19. A cellular telephone having an electroluminescent panel as a first surface of a molded portion of the telephone, said panel comprising:
a transparent first layer;
a first conductive layer overlying said first layer;
a second conductive layer,
a dielectric layer and a phosphor layer between said first conductive layer and said second conductive layer;
a protective layer overlying the second conductive layer; and
a removable release layer overlying the protective layer to support the other layers during molding.

20. A method for making an article having a luminous surface, said method comprising the steps of:
depositing a first translucent layer on a release layer;
depositing a first electrode on the first translucent layer;
depositing a phosphor layer or a dielectric layer on the first electrode;
depositing a dielectric layer or a phosphor layer on the preceding layer;
depositing a second electrode on the preceding layer;
depositing a protective layer on the second electrode;
curing the deposited layers;
removing the release layer;
placing the cured layers in a mold;
injecting resin into the mold behind the cured layers;
curing the resin;
removing the article from the mold.

21. The method as set forth in claim 20 and further including the step of:
vacuum forming the cured layers prior to injecting resin into the mold.
